(19) United States
(12) Patent Application Publication
(10) Pub. No.: US 2025/0173744 A1
(43) Pub. Date: May 29, 2025

(54) GENERATIVE AI WORKFLOW SERVICE TO CUSTOMER MATCHING

(71) Applicant: Growth Engine, Inc., Houston, TX (US)

(72) Inventors: Tri Nguyen, Houston, TX (US); Jerry Castanos, New York, NY (US); Ankur Patel, New York, NY (US); Alan Harris, Houston, TX (US); Martin Kondor, Marcali (HU); Lucy Tai, Boston, MA (US); Benjamin Durham, Medford, OR (US)

(21) Appl. No.: 18/963,340

(22) Filed: Nov. 27, 2024

Related U.S. Application Data
(60) Provisional application No. 63/603,579, filed on Nov. 28, 2023.

(51) Int. Cl. G06Q 30/0201; G06F 40/58

(52) U.S. Cl. CPC G06Q 30/0201; G06F 40/58

(57) ABSTRACT

Methods, systems, and media including: receiving a list of summarized information characterizing a company; identifying, using a language model, at least one product feature within the summarized information; retrieving one or more opportunities; identifying, using the language model, at least one opportunity feature within the one or more opportunities; calculating, using a generative analytical engine, one or more similarity metrics that characterize the relationship between the at least one product feature and the at least one opportunity feature; and generating one or more product-opportunity pairs based on the one or more similarity metrics.

### CROSS-REFERENCE TO RELATED PATENT APPLICATIONS

This application claims the benefit of U.S. Provisional Application No. 63/603,579, filed Nov. 28, 2023, the contents of which are incorporated by reference herein.

### BACKGROUND

Traditionally in the world of contracting, when a party wishes for work to be accomplished the party may submit an opportunity for various companies to perform the work. The opportunity describes various aspects of the work to be performed, critical performance parameters, and other essential terms. Companies then respond to this opportunity with a proposal, outlining their requirements to perform the work described by the opportunity. If the proposal is favorable to the requesting party, the party then accepts the company's proposal and is awarded the work. One example of this process is the United State government's Small Business Innovation Research (SBIR) program, where the federal government executes contracts with small businesses to perform work.

### SUMMARY

While the SBIR program may have been intended to help small businesses enter the world of government contracting, navigating the process can be overwhelming for a small company with no prior experience. Government Opportunities can be lengthy, confusing documents that a layperson would struggle to understand without prior contracting experience. Moreover, government bureaucracy and automation can filter out relevant company proposals due to minor issues of word choice and phrasing.

To assist companies with leveraging government contracting programs (e.g., SBIR), artificial intelligence (AI) can be used to distill information directly from the company, match the company with appropriate Opportunities, and assist the Company in submitting proposals. The AI-enabled processes described below frame the Company's experience and services in a way that will minimize the chance that their proposal will be erroneously filtered out by government bureaucracy and ensure the company is on a “level playing field” with the competition.

While the examples of government contracting and SBIR are used, it should be understood that the below processes will have applications outside of these forums. Any contracting process that outlines performance metrics in Opportunities (or an equivalent way of soliciting proposals) can serve as a framework to apply these techniques. Accordingly, the total possible applications of these techniques are limitless in the world of contract work.

While the term “company” is used throughout this disclosure to refer to the end user, this does not limit the techniques below to only companies or require any other administrative or legal requirements not otherwise explicitly described below. Because the SBIR program is designed to help small businesses, the end users of these techniques will come from all walks of industry and practice and will similarly hold many titles. Additionally, because this disclosure is not strictly limited to government contracting, there are many possible such end users.

Although described in the context of a company, the end user of the techniques of this specification can be an automated model, electronic record, or other processing system. For example, a contract to audit the cyber security of a government website can be posted as an opportunity, including the relevant technical requirements (e.g., operating system, security protocols, encryption techniques, etc.). An automated model that conducts audits that satisfy the opportunity can be represented as a “company,” such that the traits of the model are matched to the technical requirements of the audit.

Additionally, although opportunities are described in the context of contracts, essential terms, and performance parameters, an opportunity can also be represented in terms of technical requirements. For example, the technical requirements of a computing environment can be included in an opportunity such that suitable automated systems or models can be matched based on their technical capabilities.

The traits of the company are critical in determining what opportunities would be suitable. To distill this information into a format that lends itself to the SBIR process, a generative AI is used to process information associated with the company. Because one of the goals of these techniques is to make the process seamless to the company, there are various ways this can be accomplished.

For example, the company could type/manually enter one or more descriptions of their capabilities, and/or simply provide a link to their website (e.g., via a Uniform Resource Locator (URL)) which contains information associated with their business. The advantage of this method is that the company doesn't need to change how any of their information is presented and can directly port any existing materials they may have. Alternatively, or in addition, the company can provide electronic documents that describe their capabilities for processing.

Once the generative AI has received the materials from the company, the AI parses the information to generate embeddings that describe relevant information. These embeddings represent the company's capabilities in a format that can be easily compared to opportunity embeddings that will be generated later in the process. To generate the embeddings, the generative AI can perform preprocessing to format the company's information so that it can be processed more efficiently. The generative AI also receives opportunities and generates opportunity embeddings in a similar manner. These embeddings describe, among other things, critical parameters of the opportunity that will be compared to the embeddings generated for the company.

The embeddings of the company information and opportunities are then compared. As described below, various processes can be used to conduct the comparison. In some examples, the comparison generates similarity metrics for the two sets of embeddings. These similarity metrics are then used to rank or organize the opportunities the company has matched with. In some examples, once an initial set of matched opportunities are identified, a generative AI can be used to re-rank the opportunities using the associated similarity metrics as additional input. Matched opportunities can also be presented to the company. Once an opportunity or set of opportunities has been identified, the process continues by either automatically generating a proposal for the company or identifying a writer to assist the Company with drafting the proposal. In some examples, the identity of the writer can be obfuscated when providing their contact information to the company. In some examples, multiple writers can bid on the opportunity to draft the proposal for the company. In this way, a company can choose to develop a relationship with a particular writer that is best suited for their business or technical expertise.

In general, innovative aspects of the subject matter described in this specification can be embodied in a computer implemented method including: receiving a list of summarized information characterizing a company; identifying, using a language model, at least one product feature within the summarized information; retrieving one or more opportunities; identifying, using the language model, at least one opportunity feature within the one or more opportunities; calculating, using a generative analytical engine, one or more similarity metrics that characterize the relationship between the at least one product feature and the at least one opportunity feature; and generating one or more product-opportunity pairs based on the one or more similarity metrics.

Other embodiments include one or more non-transitory computer storage media encoded with computer program instructions that when executed by one or more computers cause the one or more computers to perform operations including: receiving a list of summarized information characterizing a company; identifying, using a language model, at least one product feature within the summarized information; retrieving one or more opportunities; identifying, using the language model, at least one opportunity feature within the one or more opportunities; calculating, using a generative analytical engine, one or more similarity metrics that characterize the relationship between the at least one product feature and the at least one opportunity feature; and generating one or more product-opportunity pairs based on the one or more similarity metrics.

Other embodiments include a system including: one or more computers and one or more storage devices storing instructions that are operable, when executed by the one or more computers, to cause the one or more computers to perform operations comprising; receiving a list of summarized information characterizing a company; identifying, using a language model, at least one product feature within the summarized information; retrieving one or more opportunities; identifying, using the language model, at least one opportunity feature within the one or more opportunities;

calculating, using a generative analytical engine, one or more similarity metrics that characterize the relationship between the at least one product feature and the at least one opportunity feature; and generating one or more product-opportunity pairs based on the one or more similarity metrics.

The foregoing and other embodiments can each optionally include one or more of the following features, alone or in combination.

In some examples, the embodiments include: sorting, using the generative analytical engine and the similarity metrics, the one or more product-opportunity pairs based on their associated similarity metrics; and, identifying a particular subset of the one or more product-opportunity pairs to be output to a user.

In some examples, receiving a list of summarized information characterizing a company includes generating, using a generative analytical engine, a list of summarized information characterizing a company.

In some examples, the embodiments include: applying a filter that removes a subset of the one or more product-opportunity pairs based on the respective similarity metrics being below a threshold value.

In some examples, calculating the one or more similarity metrics includes: generating a product text embedding for each of the product features; performing a cosine similarity vector search on each of the product text embeddings and an opportunity text embedding retrieved from a database; and generating the similarity metric using the results of the cosine similarity vector search.

In some examples, generating the list of summarized information characterizing the company includes: receiving, at the generative analytical engine, a Uniform Resource Locator (URL) to a webpage containing information associated with the company; and, using the generative analytical engine, parsing the information to generate summarized information.

In some examples, generating the list of summarized information characterizing the company includes: receiving, at the generative analytical engine, one or more electronic documents containing information associated with the company; and, using the generative analytical engine, parsing the information to generate summarized information.

In some examples, the embodiments include: in response to receiving user input that selects a particular product-opportunity pair from the one or more product-opportunity pairs, generating a proposal; and, outputting the proposal to the user.

In some examples, the embodiments include: in response to receiving user input that selects a particular product-opportunity pair from the one or more product-opportunity pairs, identifying an agent to generate a proposal directed to the particular product-opportunity pair; and, sharing the identity of the agent with the user.

In some examples, the generative analytical engine is a generative artificial intelligence (AI).

In some examples, sorting the product-opportunity pairs comprises ranking the product-opportunity pairs based on their similarity metrics.

Particular aspects of the subject matter described in this specification can be implemented so as to realize one or more of the following advantages. The ability to leverage AII in securing SBIR contracts can be invaluable for a small business that may use these contracts to expand. Traditionally, the SBIR process has been a barrier to small companies unfamiliar with the government contracting process, despite the goal of the SBIR program to promote the development of small businesses. The increased accuracy of proposals generated using this process also reduces government wastage and streamlines the contracting process.

The details of one or more aspects of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example overview of a process for matching a company with a proposal request.

FIG. 2A is an example process for generating a company profile.

FIG. 2B is an example process for matching company products to opportunities.

FIG. 2C is continuation of an example process for matching company products to opportunities.

FIG. 3 is an example first process for matching a company with a proposal request.

FIG. 4 is an example second process for matching a company with a proposal request.

FIG. 5 is an example process for generating a proposal.

FIG. 6A is an example graphical user interface (GUI) displaying a company profile.

FIG. 6B is another example GUI displaying a company profile.

FIG. 6C is an example GUI displaying a list of opportunities.

FIG. 7 is a block diagram of an example computer system that can be used to perform operations described.

### DETAILED DESCRIPTION

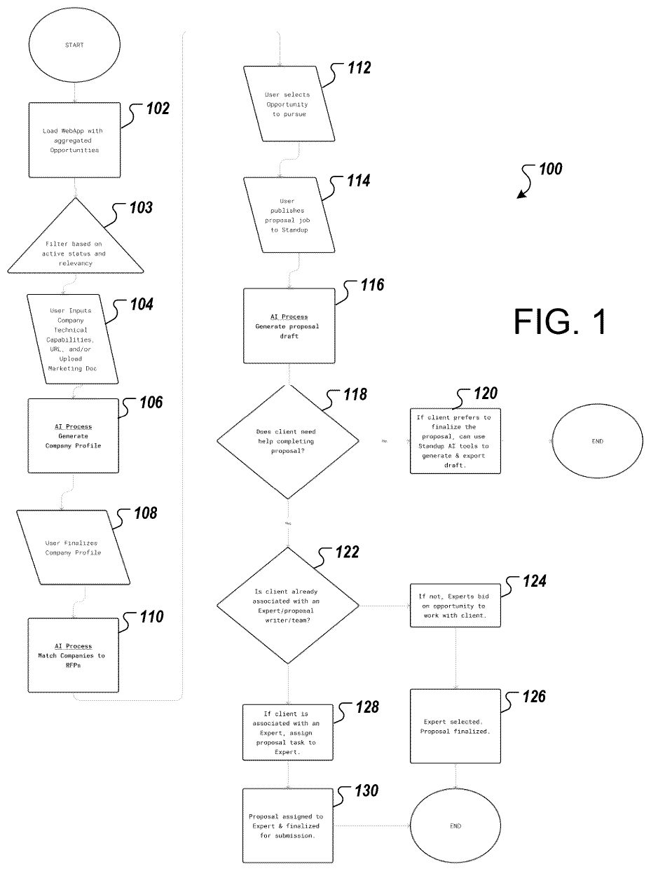

FIG. 1 is an example overview of a process 100 for matching a company with a proposal request. The example process includes receiving aggregated opportunities 102, accepting user input 104, generating a company profile 106, finalizing the company profile 108, matching companies to opportunities 110, user selection of an opportunity 112, a user publishing an initial proposal 114, and generating a proposal draft 116. Additionally, in some examples, the process 100 includes determining if further edits are required to the proposal 118 and either allowing the company to make further edits to the drafted proposal 120 or submitting the generated proposal to a writer 122.

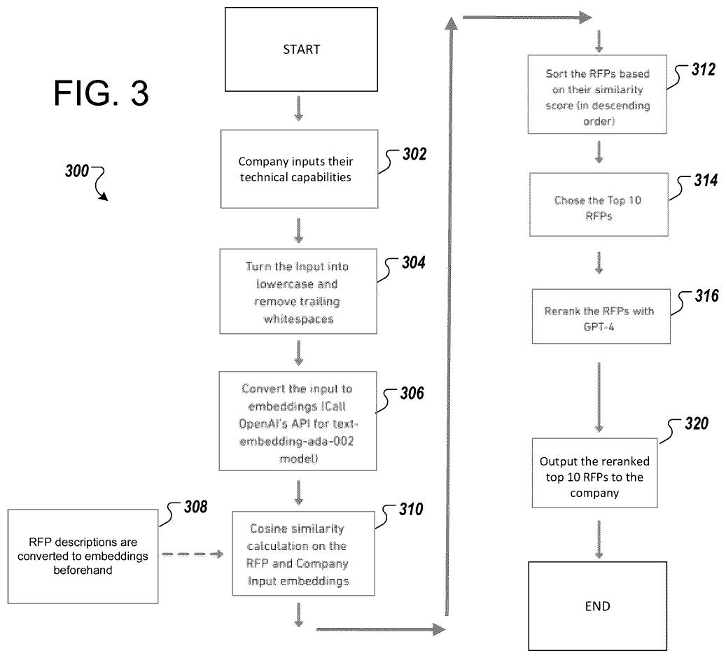

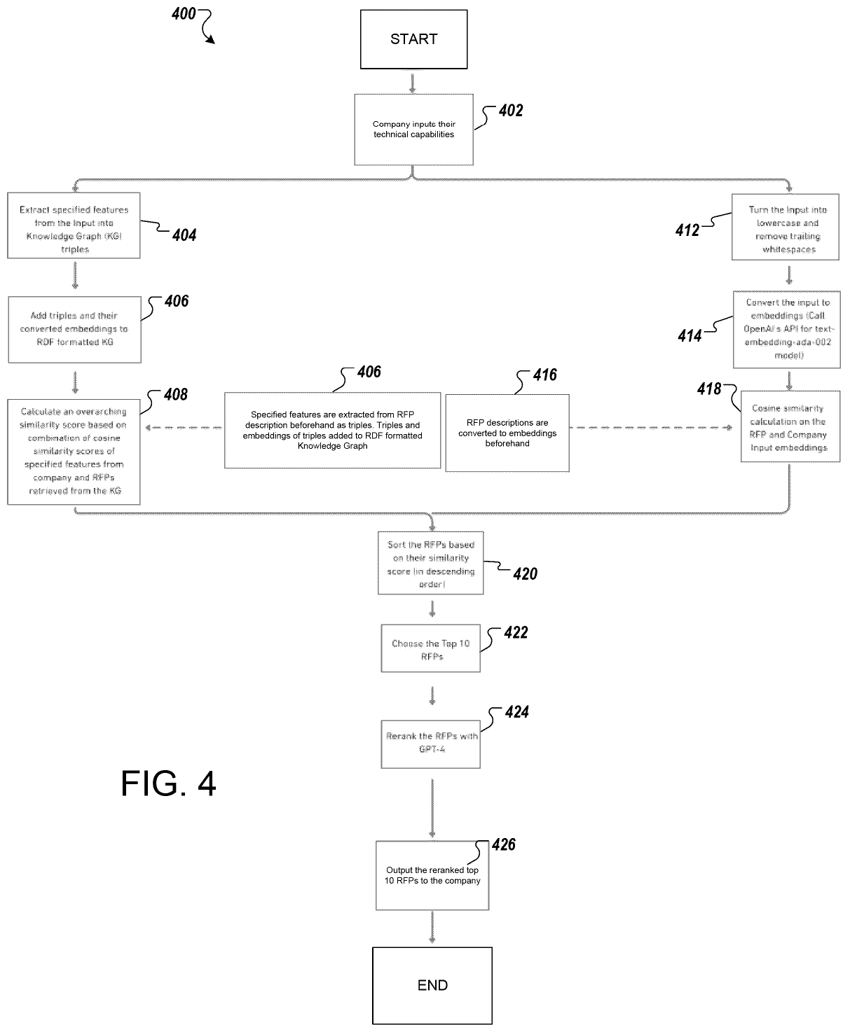

The example process 100 begins with receiving aggregated opportunities 102. In some examples, these opportunities can be retrieved over the internet from a website database. In other examples, the user can load opportunities manually that are to be evaluated. In addition to opportunities, other grants, Requests for Information (RFIs), Requests for Quotes (RFQs), Requests for Proposals (RFPs), Broad Agency Announcements (BAAs), solicitations, and opportunities can be loaded into process 100 and evaluated in the manner described below. The processing of opportunities and other documents is discussed below with respect to FIGS. 3-4 below. In some examples, further filtering 103 can be performed on the retrieved opportunities.

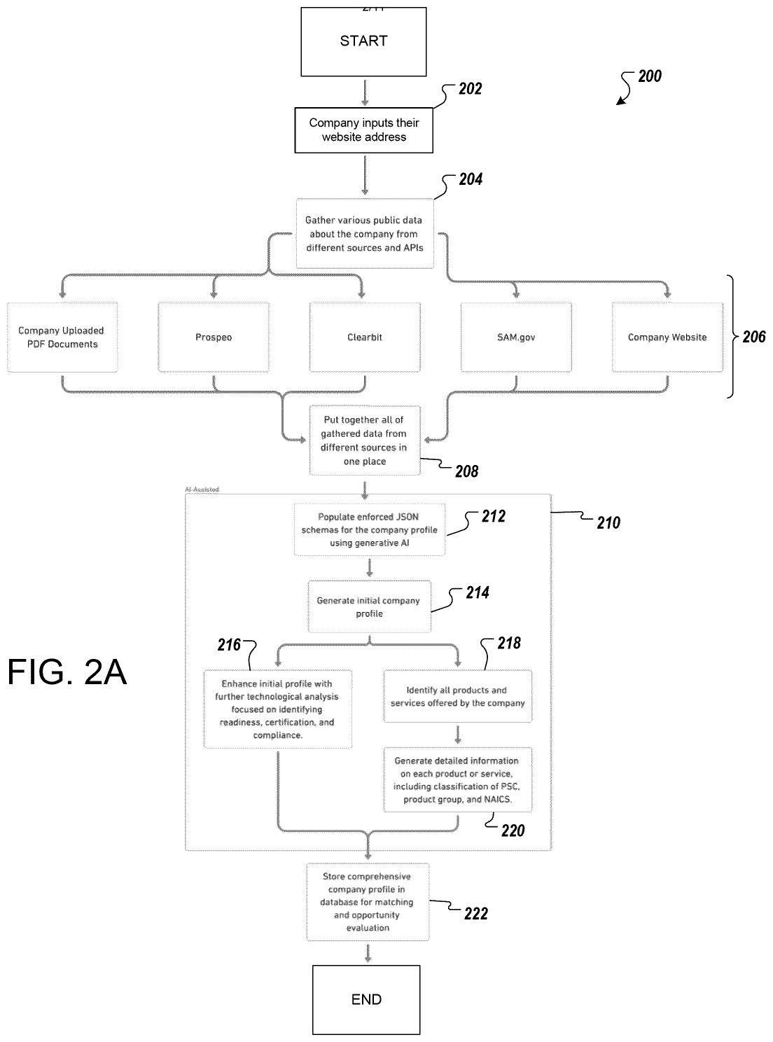

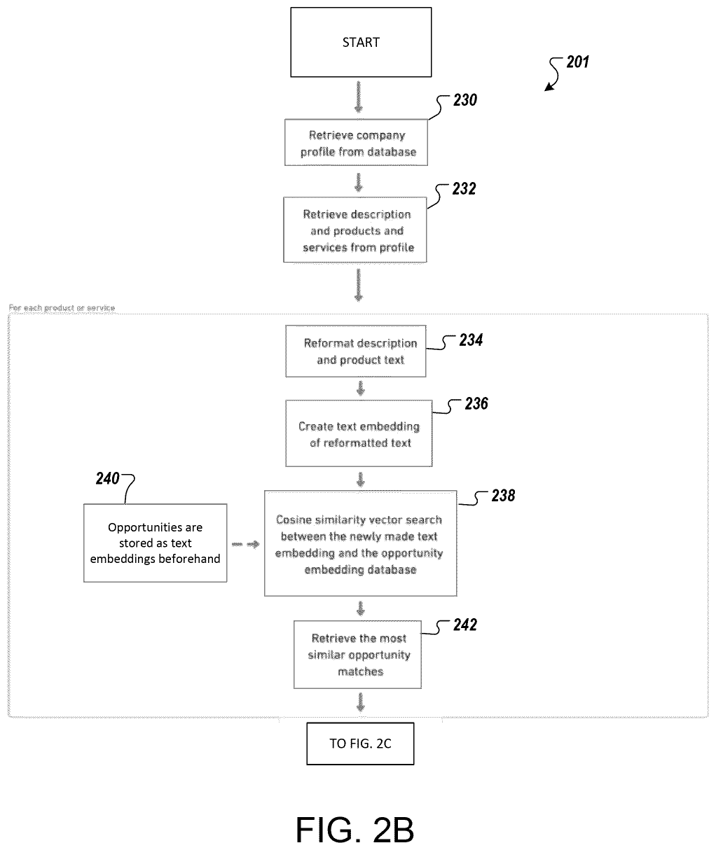

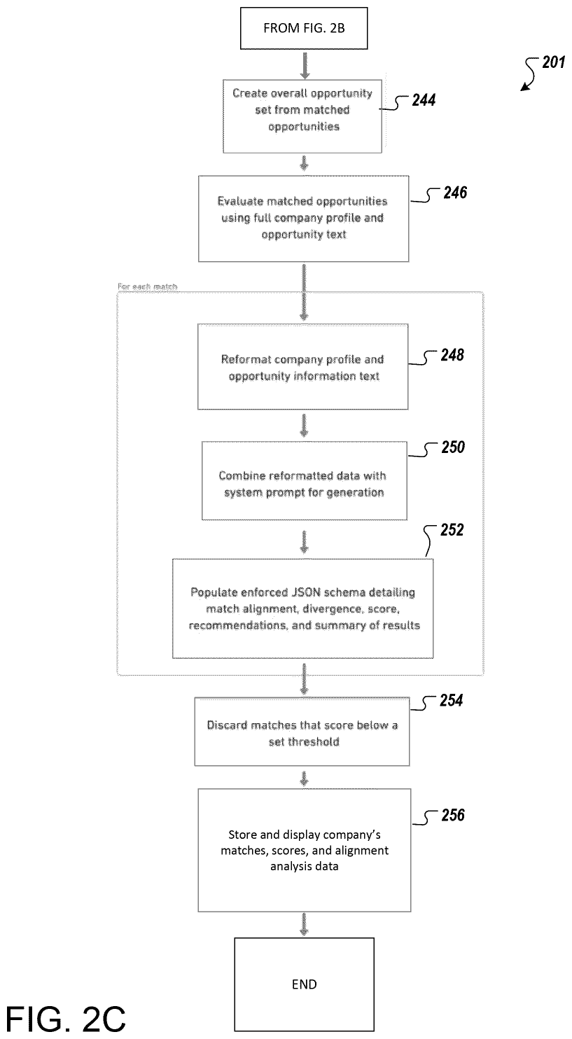

Next, the process 100 continues with accepting user input 104 that describes a company. In some examples, this input is in the form of a URL to a company website. In other examples, a user can manually upload electronic documents that describe the company (e.g., marketing documents, white papers, mission statements, etc.). Using this information, a company profile is then generated 106 by a generative AI. This process will be described in more detail with respect to FIG. 2A below.

A generative AI is then used to match the company to opportunities 110 using the generated company profile and present them to the user. This matching process is performed using various algorithms described in detail below. Once suitable opportunities are identified, the user selects one or more of the opportunities to pursue 112 and publishes an initial proposal 114. In some examples, this initial proposal contains performance parameters and other essential terms known to the company (e.g., a price, period of period of performance, quantity of materials, etc.).

Once the initial proposal draft is received 114, a generative AI creates a proposal draft 116 based on the input. This AI generated proposal accepts and reworks the user's input to maximize the probability that it will be received favorably by the contracting officer or agency (e.g., the SBIR). The generative AI can employ any relevant knowledge regarding the underlying contracting process when generating the proposal, to include past successful contracts, training data, and operating instructions.

After the proposal has been generated by the AI, the company is presented with the options for completing the proposal 118. The company can either further modify the proposal by interacting with the AI 120, or request that a writer finish the proposal draft 122. If a writer is already associated with the company 128, the writer is tasked to complete the proposal 130. If not, bids are solicited from writers to finish the proposal 124 and the company selects a writer for the work 126.

FIG. 2A is an example process 200 for generating a company profile. The example process 200 includes receiving input from the company 202, gathering public data 204, various sources of public data 206, aggregating data 208, deploying a generative AI to summarize the data 210, and storing the data for matching and further evaluation 222.

In some examples, the process 200 of building a company profile begins with receiving information provided by the company 202. This information can include a URL to a company website, publications from the company, and other electronic documents that can be parsed by a generative AI. It should be noted that any document that can be condensed into an AI prompt can be provided at this stage. For example, the company can provide a mission statement that outlines the various services the company provides and highlights the advantages of their services. In another example, a company website (provided in the form of a URL) can contain a surplus of information describing company services and products. Advantageously, a URL is effortless for the company to provide, and in some cases, requires no additional formatting or modification of the information contained therein by the user.

In some examples, the process 200 can gather additional data 204 from various public sources 206. These sources can include, but are not limited to, public company documents, information obtained from search engines, third party information, governmental information, standards and specifications, financial data, and other readily accessible information. In some examples, data source Application Programming Interfaces (APIs) are deployed to gather the additional data 204, which provide the data of different companies with names similar or identical to the provided company name. In some examples, this similarity includes a threshold value, below which data is discarded. In other examples, the user can be prompted to confirm data 204 retrieved by the APIs.

In some examples, the process 200 then aggregates the acquired data for further processing 208. For example, data from multiple sources can be examined to see what data may be duplicative or contradictory. Additionally, data that is related can be structured to illustrate dependency or similarity.

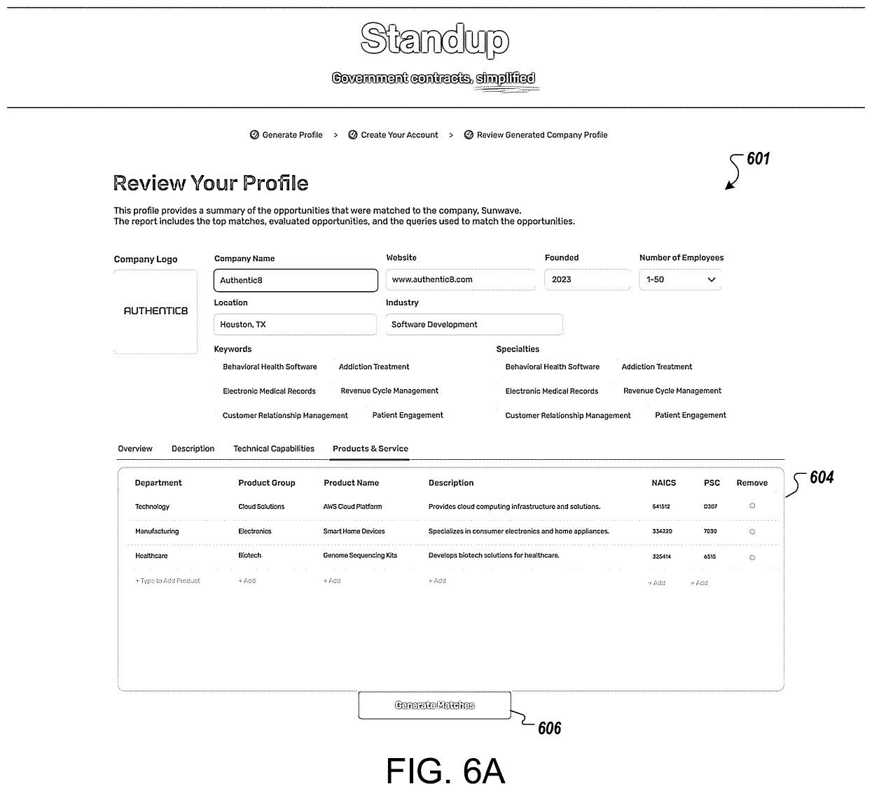

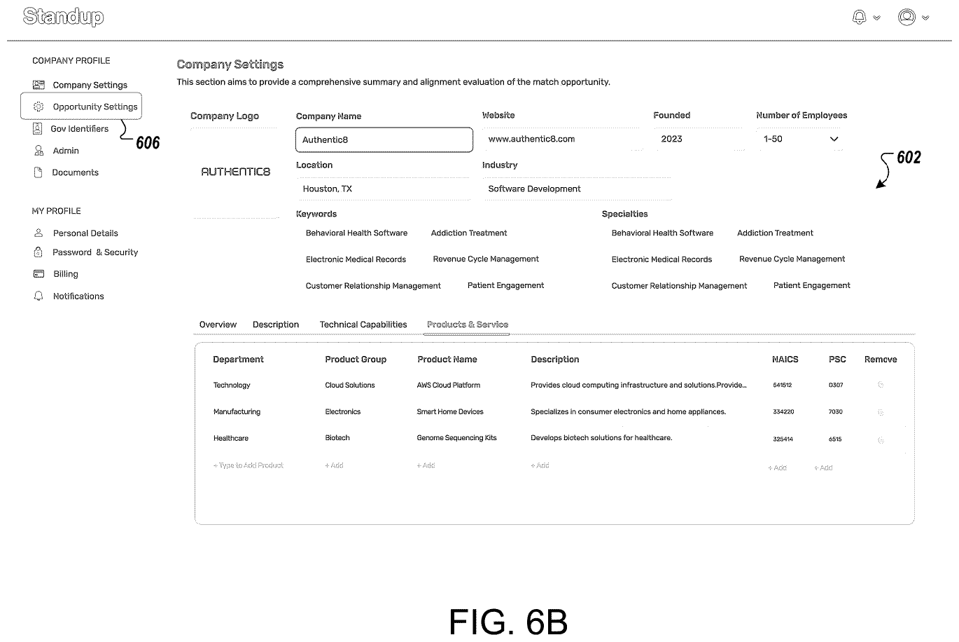

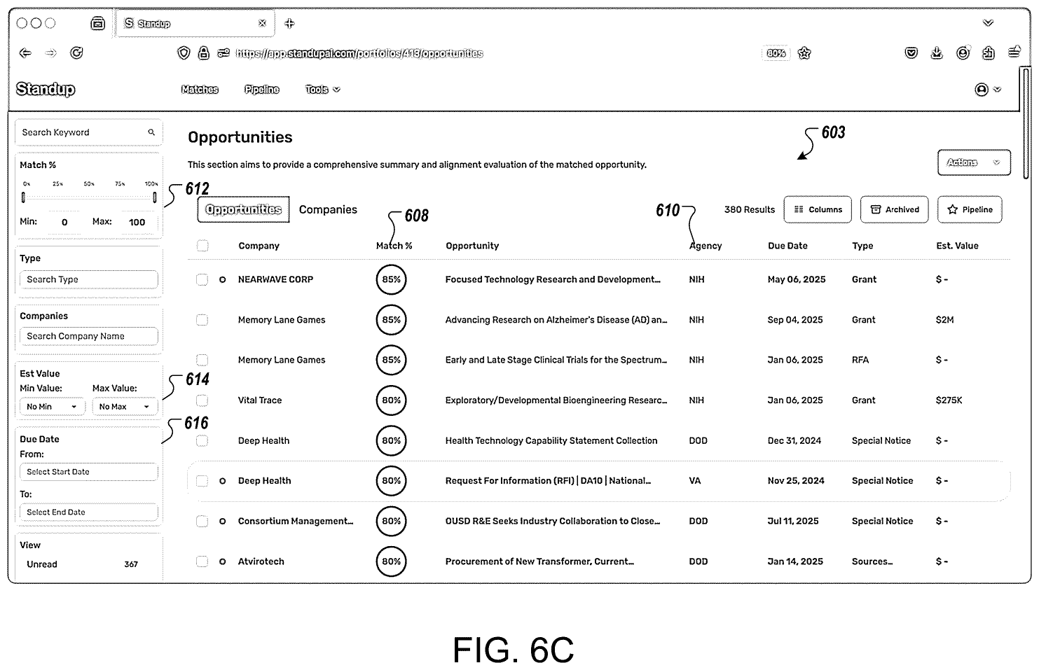

The process 200 then deploys a generative AI to process the aggregated data 210. The use of generative AI includes, in some examples, populating a schema 212, generating the initial company profile 214, enhancing the company profile 216, identifying products and services offered by the company 218, and generating detailed information for each of the products and services 220. In some examples, process 200 is initiated by a user through a GUI (e.g., GUI 601 discussed in FIG. 6A below). In some examples, matching using processes 200 and 201 can be initiated with a “one-click” button within the GUI (e.g., button 606 discussed in FIG. 6A below). The generative AI steps described below can be performed by various AI products, for example, a language model or generative analytical engine.

The use of generative AI begins with, in some examples, populating a schema 212 based on the aggregated data. This schema can be, for example, a text-based format such as JavaScript Object Notation (JSON). The generation of a schema 212 formats the aggregated data into a format that can be easily transmitted and parsed during subsequent steps in process 200 or 201.

Next, an initial company profile is generated 214. This process includes, for example, parsing the aggregated data to determine company features. These features include, for example, a company name, a company description, a company website, a company domain name or URL, alternative company names, social media pages and URLs, a legal name, an employer identification number (EIN), a Product Service and Code (PSC) designation, a North American Industry Classification System (NAICS) code (to include a primary NAICS code), a competitive advantage associated with the company, a procurement readiness assessment, a scalability assessment, a deployment capability, certifications and compliances, an organization type, company specialties, a company industry, a company founding date or year, a company size (e.g., by employee number, value, or market share), company technical capabilities, company products and services, company technology areas, keywords associated with the company, a company overview, a company location, and a company logo (to include other intellectual property associated with the company, for example, trademarks and copyrights). Once these company features have been determined, they are then aggregated into a company profile 214 for further use by process 200 and 201.

In some examples, the company profile is further enhanced with analysis of the collected features 216. For example, a company's readiness to perform a certain service can be determined and the associated feature can be updated accordingly. The same can be done for other features, for example, areas that require certification or compliance.

The process continues with identifying products and services offered by the company 218. In some examples, this processing extracts features from the aggregated data that describe the services or products the company provides to create product features. For example, these features can include physical products (e.g., valves, fasteners, machinery, building materials, chemicals, food products, raw materials, etc.), services offered by the company (machining, welding, inspection, fabrication, processing, contracting, energy services, etc.), digital products (e.g., cloud computing, Software as a Service (SaaS) platforms, digital security, quantum computing companies, etc.), biological and pharmaceutical products or services (biotech, petrochemical, medical, research and development, etc.), specifications (American National Standard Institute (ANSI), Military Specification (MIL-SPEC), International Telecommunication Union (ITU), American Society for Testing and Materials (ASTM), etc.), and other information that would be relevant to the requirements of an opportunity.

Once product features have been generated, the process continues by generating additional information for each of the product features 220. For example, additional features relevant to each of the product features are extracted, for example, a product name, a product description, a product department, a product group, keywords associated with the product, a simplified product summary, a PSC designation, a NAICS code, and a product group.

After the company profile is generated along with the accompanying product features, the company profile and product features are then stored in a database for further matching and opportunity evaluation 222. For example, the company profile generated as part of process 200 can be used in process 201 below to match products to opportunities.

FIGS. 2B and 3B are an example process 201 for matching company products to opportunities. The example process 201 includes retrieving a company profile from a database 230, retrieving description and product services from the company profile 232, reformatting the description and product text 234, creating a text embedding of the reformatted text 236, performing a cosine similarity vector search 238, retrieving a similar opportunity 242, creating an overall opportunity set from matched opportunities 244, evaluating the matched opportunities 246, reformatting the company profile and opportunity information 248, combining the reformatted data 250, populating a schema describing the data 252, discarding matches below a threshold 254, and storing or displaying the resulting matches 256.

The example process 201 begins with retrieving a company profile from a database 230. In some examples, this company profile was generated in a process similar to what is described above in process 200. In other examples, the company profile can be provided from another source.

Next, the example process 201 continues with retrieving the description of products and services from the company profile 232. For example, previously identified company and product features determined in process 200 above can be retrieved. In some examples, the gathered descriptions are then reformatted as product text 234. It should be understood that the term “product text” can also include text reformatted for a service, or other similar company offerings.

In some examples, product text embeddings are then created for the reformatted product text 236. Converting gathered product text into embeddings can be beneficial for subsequent processing in example process 201, for example, by machine learning models and artificial intelligence techniques that receive input in the form of embeddings.

In some examples, opportunity features are extracted in a process similar to the process for extracting product features. For example, an opportunity (e.g., an RFP) can be received and processed using generative AI to extract features that relate to company or product features (e.g., a Product Service and Code (PSC) designation, a North American Industry Classification System (NAICS) code, or any other feature described above). Once opportunity features have been extracted, they are stored as opportunity text embeddings 240.

In some examples, opportunity features or opportunity text embeddings can be used to correlate company profiles. For example, a set of opportunity features or opportunity text embeddings can be divided into different performance requirements, each of which can be satisfied by a different company profile. Upon determining that a set of opportunity features or opportunity text embeddings includes performance requirements that correlate to multiple companies, an alert can be sent to one or all of the companies describing this relationship. This can be advantageous in allowing multiple companies to pool their resources to complete for an opportunity they may not individually be capable of executing. For example, company A can meet requirement 1, but not requirement 2, and identify that company B can complete requirement 2. In this case, company A could engage company B to satisfy all the requirements of the opportunity and bid on the work.

In some examples, the product text embeddings are then used to perform a cosine similarity vector search 238 that quantifies the similarity between the product text embeddings and opportunity text embeddings retrieved from a database 240. The process of performing a cosine similarity vector search on two input vectors (e.g., text embeddings) is well understood and not replicated in detail here. While the cosine similarity vector search is depicted in example process 201, it should be understood that other mathematical techniques can also be applied (either alternatively or in addition), for example, Euclidean distance, Manhattan distance, and Hamming distance.

Next, the most similar opportunities (referred to as product-opportunity pairs) are identified by generating a similarity metric using the results of the cosine similarity vector search 242. In some examples, the similarity metric is a mathematical construct, such as a percentage or decimal. In other cases, the similarity metric can be defined as a point on a spectrum. In some examples, once similarity metrics have been determined, an overall opportunity set is created 244 from the product-opportunity pairs that have favorable similarity metrics. The overall opportunity set can include any number of product-opportunity pairs that have favorable similarity metrics.

In some examples, the product-opportunity pairs are then evaluated using the full company profile 246. First, for each product-opportunity pair, the company profile and opportunity information are reformatted into text 248. Next, the reformatted text is combined with a system prompt for generation 250. In some examples, the reformatted text is combined as a user prompt. Finally, a schema is populated 252 that further details characteristics that define the product-opportunity pair. In some examples, this schema is the JSON schema described above in process 200. Example characteristics that can be defined in the schema include an alignment value, a divergence value, a score value, an analysis summary, and recommendations for the product-opportunity pair. In some examples, product-opportunity pairs with similarity metrics below a certain threshold are then discarded 254.

Finally, once suitable product-opportunity pairs have been created, these matches are then stored or displayed to the user 256. For example, product-opportunity pairs can be stored in a database or transmitted to another device for further disposition. Additionally, product-opportunity pairs can be displayed to the user for further consideration, for example, using the example GUls depicted in FIGS. 6A-6C.

FIG. 3 is an example first process 300 for matching a company with a proposal request. The example process 300 includes receiving input from a company 302, formatting the input 304, generating embeddings for the input using a generative AI 306, receiving opportunity descriptions and generating embeddings for the opportunities 308, deploying an algorithm to generate similarity metrics for the company and opportunity embeddings 310, sorting 312 and selecting 314 a subset of matched opportunities, reranking the selected opportunities using a generative AI 316, and outputting the opportunities to the company 320.

In example process 300, the company provides input regarding their capabilities 302. This input is described above with reference to FIG. 2. In some examples, additional data formatting is performed when generating embeddings based on the company input. For example, the process 300 can convert all extracted text to lowercase and remove trailing white spaces 304. This formatting increases the accuracy of the generative AI when interpreting the resulting prompt that describes the company profile.

Next, example process 300 deploys an algorithm to evaluate the similarity of the company and opportunity embeddings 310. In some examples, this algorithm is a cosine similarity vector search as described above in FIGS. 2B-2C. In other examples, other algorithms can be used. The output of the algorithm is a set of similarity metrics (or similarity “scores”) that quantify the similarity of the company and opportunity embeddings. In some examples, similarity metrics are expressed as a numerical score. Alternatively, or in addition, similarity metrics can be expressed qualitatively. In some examples, the matching of a company to an opportunity (expressed by a set of similarity metrics that define the similarity of the respective embeddings) is referred to as a company-request pair.

In some examples, the generated company-request pairs are then sorted based on their associated similarity metrics 314. For example, the total number of company-request pairs can be sorted by a similarity score in descending order. Other sorting arrangements are possible. Next, a subset (e.g., ten) of company-request pairs are selected 314. In some examples, once a subset of company-request pairs are identified, a generative AI is deployed to re-rank the subset of company-request pairs 316. The final list of company request pairs is then provided to the user 320.

FIG. 4 is an example second process 400 for matching a company with a proposal request. The example process 400 includes receiving input from a company 402, formatting the input 412, generating embeddings for the input using a generative AI 414, receiving opportunity descriptions and generating embeddings for the opportunities 416, deploying an algorithm to generate similarity metrics for the company and opportunity embeddings 418, sorting 420 and selecting 422 a subset of matched opportunities, reranking the selected opportunities using a generative AI 424, and outputting the opportunities to the company 426.

Example process 400 performs similar steps to what is described with respect to example process 300, with the addition of a separate workflow that includes extracting opportunity features into Knowledge Graph (KG) triples 404, adding the triples and embeddings to a Resource Data Framework (RDF) formatted KG 406, and calculating an overarching similarity score based on the combination of similarity score calculated by the algorithm and the output of the KG 408.

A semantic triple (or RDF triple) is a sequence of three entities that codifies a statement about semantic data in the form of subject-predicate-object expressions. In example process 400, the addition of triples is used to codify the existing features that are extracted from the company profile and opportunities (as described above in FIGS. 2-3). In this way, input can be provided to the generative AI with underlying context in a machine-readable-friendly format that further increases the accuracy of the resulting company-request pair matches.

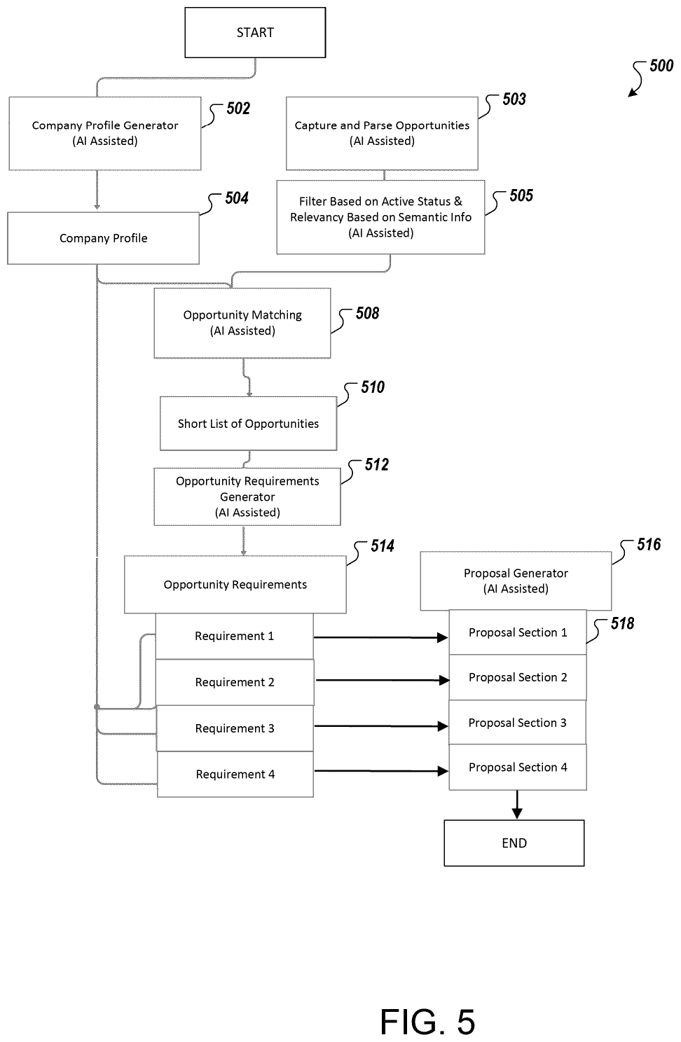

FIG. 5 is an example process 500 for generating a proposal. In some examples, process 500 uses the same techniques as described above for FIG. 1-4. Example process 500 includes an AI generated company profile generator 502, a collection of opportunities 503, one or more company profiles 504, filtering opportunities 505, AI generated opportunity matching 508, a generated opportunity shortlist 510, an AI generated opportunity requirements generator 512, one or more opportunity requirements 514, an AI generated proposal generator 516, and one or more proposal sections 518.

In some examples, the process of matching companies to opportunities (components 502 to 510) occurs as discussed above in FIGS. 1-4. Additionally, example process 500 includes an AI generated opportunity requirements generator 512 that identifies features within the shortlisted opportunities 510. In some examples, these features are performance parameters or essential terms that must be satisfied. After opportunity requirements 514 have been extracted, an AI generated proposal generator 516 creates proposal sections 518 to match to the extracted opportunity requirements 514. For example, a generated proposal section 518 can be a price, period of performance, quantity of material, or other contract parameter that would otherwise satisfy the requirements of the extracted opportunity requirement 514. Once all the desired proposal to opportunity requirement matching has concluded, the process terminates and the proposal is generated.

FIG. 6A is an example graphical user interface (GUI) 601 displaying a company profile. The example GUI 601 depicts a dashboard for the company to review and modify information collected as part of the processes described above (e.g., a website, industry, or specialty). Additionally, GUI 601 includes a listing of products 604 that have been identified for the company, to include information related to the opportunity. GUI 601 also provides a button 606 that, when selected, generates matches for the company and products 604. FIG. 6B is another example GUI 602 displaying a company profile. GUI 602 is similar to GUI 601, with the addition of a menu with multiple settings that allow a company to review and edit collected information (e.g., opportunity settings 606).

FIG. 6C is an example GUI 603 displaying a list of opportunities. GUI 603 includes a list of opportunities, including a company name, opportunity name, a match indicator 608, an originating agency for the opportunity 610, and other information associated with the opportunity. In some examples, the match indicator 608 is a percentage that is a result of the matching process described above in FIGS. 2B and 2C. In some examples, the match indicators 608 for matches that are especially beneficial for the company are emphasized (e.g., colored green or bolded).

Additionally, GUI 603 provides various filters that can be applied to further refine the displayed opportunities. For example, a match filter 612 can be used to specify that only matches above a certain threshold are displayed (e.g., those with a value higher than 75%). As another example, value filter 614 can be used to filter the displayed opportunities by an expected minimum or maximum value. As yet another example, a time filter 616 can be applied to filter opportunities by a date range during which the opportunity is expected to run. Other filters and options are possible, to include filtering by a company name, opportunity type, or keyword.

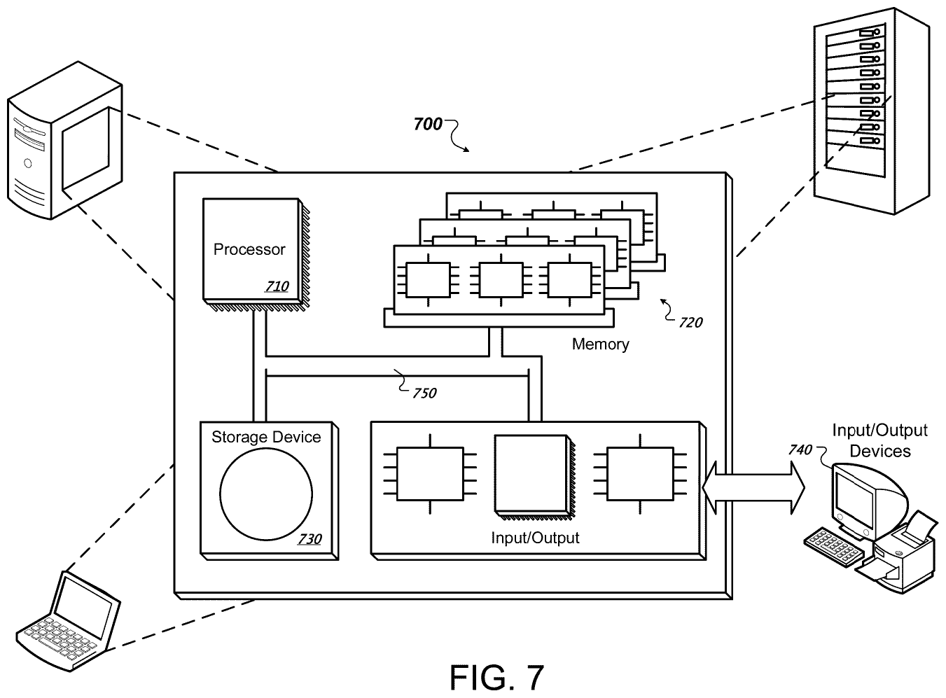

FIG. 7 is block diagram of an example computer system 700 that can be used to perform operations described above. The system 700 includes a processor 710, a memory 720, a storage device 730, and an input/output device 740. Each of the components 710, 720, 730, and 740 can be interconnected, for example, using a system bus 750. The processor 710 is capable of processing instructions for execution within the system 700. In some implementations, the processor 710 is a single-threaded processor. In another implementation, the processor 710 is a multi-threaded processor. The processor 710 is capable of processing instructions stored in the memory 720 or on the storage device 730.

The memory 720 stores information within the system 700. In one implementation, the memory 720 is a computer-readable medium. In some implementations, the memory 720 is a volatile memory unit. In another implementation, the memory 720 is a non-volatile memory unit.

The storage device 730 is capable of providing mass storage for the system 700. In some implementations, the storage device 730 is a computer-readable medium. In various different implementations, the storage device 730 can include, for example, a hard disk device, an optical disk device, a storage device that is shared over a network by multiple computing devices (e.g., a cloud storage device), or some other large capacity storage device.

The input/output device 740 provides input/output operations for the system 700. In some implementations, the input/output device 740 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to peripheral devices, e.g., keyboard, printer and display devices. Other implementations, however, can also be used, such as mobile computing devices, mobile communication devices, set-top box television client devices, etc.

Although an example processing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Aspects of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Aspects of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, aspects of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Aspects of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some aspects, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any aspect or on the scope of what may be claimed, but rather as descriptions of features that may be specific to particular aspects of particular aspects. Certain features that are described in this specification in the context of separate aspects can also be implemented in combination in a single embodiment. Conversely, various features that are described in the context of a single embodiment can also be implemented in multiple aspects separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the aspects described above should not be understood as requiring such separation in all aspects, and it should be understood that the described program components and systems can generally be integrated together in a single software product or packaged into multiple software products.

Particular aspects of the subject matter have been described. Other aspects are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

What is claimed is:

1. A computer implemented method comprising:
receiving a list of summarized information characterizing a company;
identifying, using a language model, at least one product feature within the summarized information;
retrieving one or more opportunities;
identifying, using the language model, at least one opportunity feature within the one or more opportunities;
calculating, using a generative analytical engine, one or more similarity metrics that characterize the relationship between the at least one product feature and the at least one opportunity feature; and
generating one or more product-opportunity pairs based on the one or more similarity metrics.

2. The method of claim 1, further comprising:
sorting, using the generative analytical engine and the similarity metrics, the one or more product-opportunity pairs based on their associated similarity metrics; and,
identifying a particular subset of the one or more product-opportunity pairs to be output to a user.

3. The method of claim 1, wherein receiving a list of summarized information characterizing a company comprises generating, using a generative analytical engine, a list of summarized information characterizing a company.

4. The method of claim 1, further comprising:
applying a filter that removes a subset of the one or more product-opportunity pairs based on the respective similarity metrics being below a threshold value.

5. The method of claim 1, wherein calculating the one or more similarity metrics further comprises:
generating a product text embedding for each of the product features;
performing a cosine similarity vector search on each of the product text embeddings and an opportunity text embedding retrieved from a database; and
generating the similarity metric using the results of the cosine similarity vector search.

6. The method of claim 1, wherein generating the list of summarized information characterizing the company further comprises:
receiving, at the generative analytical engine, a Uniform Resource Locator (URL) to a webpage containing information associated with the company; and,
using the generative analytical engine, parsing the information to generate summarized information.

7. The method of claim 1, wherein generating the list of summarized information characterizing the company further comprises:
receiving, at the generative analytical engine, one or more electronic documents containing information associated with the company; and,
using the generative analytical engine, parsing the information to generate summarized information.

8. The method of claim 1, further comprising:
in response to receiving user input that selects a particular product-opportunity pair from the one or more product-opportunity pairs, generating a proposal; and,
outputting the proposal to the user.

9. The method of claim 1, further comprising:
in response to receiving user input that selects a particular product-opportunity pair from the one or more product-opportunity pairs, identifying an agent to generate a proposal directed to the particular product-opportunity pair; and,
sharing the identity of the agent with the user.

10. The method of claim 1, wherein the generative analytical engine is a generative artificial intelligence (AI).

11. The method of claim 1, wherein sorting the product-opportunity pairs comprises ranking the product-opportunity pairs based on their similarity metrics.

12. One or more non-transitory computer storage media encoded with computer program instructions that when executed by one or more computers cause the one or more computers to perform operations comprising:
receiving a list of summarized information characterizing a company;
identifying, using a language model, at least one product feature within the summarized information;
retrieving one or more opportunities;
identifying, using the language model, at least one opportunity feature within the one or more opportunities;
calculating, using a generative analytical engine, one or more similarity metrics that characterize the relationship between the at least one product feature and the at least one opportunity feature; and
generating one or more product-opportunity pairs based on the one or more similarity metrics.

13. The media of claim 12, further comprising:
sorting, using the generative analytical engine and the similarity metrics, the one or more product-opportunity pairs based on their associated similarity metrics; and,
identifying a particular subset of the one or more product-opportunity pairs to be output to a user.

14. The media of claim 12, wherein receiving a list of summarized information characterizing a company comprises generating, using a generative analytical engine, a list of summarized information characterizing a company.

15. The media of claim 12, further comprising:
applying a filter that removes a subset of the one or more product-opportunity pairs based on the respective similarity metrics being below a threshold value.

16. The media of claim 12, wherein calculating the one or more similarity metrics further comprises:
generating a text embedding for each of the product features;
performing a cosine similarity vector search on each of the text embeddings and an opportunity text embedding retrieved from a database; and
generating the similarity metric using the results of the cosine similarity vector search.

17. The media of claim 12, wherein generating the list of summarized information characterizing the company further comprises:
receiving, at the generative analytical engine, a Uniform Resource Locator (URL) to a webpage containing information associated with the company; and,
using the generative analytical engine, parsing the information to generate summarized information.

18. The media of claim 12, wherein generating the list of summarized information characterizing the company further comprises:
receiving, at the generative analytical engine, one or more electronic documents containing information associated with the company; and,
using the generative analytical engine, parsing the information to generate summarized information.

19. The media of claim 12, further comprising:
in response to receiving user input that selects a particular product-opportunity pair from the one or more product-opportunity pairs, generating a proposal; and,
outputting the proposal to the user.

20. A system comprising:
one or more computers and one or more storage devices storing instructions that are operable, when executed by the one or more computers, to cause the one or more computers to perform operations comprising;
receiving a list of summarized information characterizing a company;
identifying, using a language model, at least one product feature within the summarized information;
retrieving one or more opportunities;
identifying, using the language model, at least one opportunity feature within the one or more opportunities;
calculating, using a generative analytical engine, one or more similarity metrics that characterize the relationship between the at least one product feature and the at least one opportunity feature; and
generating one or more product-opportunity pairs based on the one or more similarity metrics.
